(19) United States
(12) Patent Application Publication
(10) Pub. No.: US 2008/0077538 A1
(43) Pub. Date: Mar. 27, 2008

(54) Public Trade Execution Analytics

(76) Inventor: Gregory Schebece, Dix Hills, NY (US)

Correspondence Address: GREGORY SCHEBECE, 15 WOODEDGE DRIVE, DIX HILLS, NY, 11746, US

(21) Appl. No.: 11/833,383

(22) Filed: Aug. 3, 2007

Related U.S. Application Data
(60) Provisional application No. 60/853,316, filed on Sep. 26, 2006.

(51) Int. Cl. G06Q 40/00

(52) U.S. Cl. 705/36 R

(57) ABSTRACT

The invention is a central data repository that will gather, aggregate, archive and relate various sets of publicly available trade execution, quote and trade print data based on SEC Regulation NMS Rule 605 regulations, order routing data based on SEC Regulation NMS Rule 606 Order Routing Disclosure regulations and market data available from the Consolidated Quotation System “CQS” quote and trade data. The statistical results will be available over the internet through a centralized database with various query functions including historical and charting capabilities.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### FIELD OF THE INVENTION

Securities and Exchange Commission (“SEC”) Regulation NMS

### BACKGROUND OF THE INVENTION

The Securities and Exchange Commission (“SEC”) requires market centers to prepare and make available to the public monthly reports in electronic form that categorize their order executions and include statistical measures of execution quality. To facilitate comparisons across market centers, the Rule adopts basic measures of execution quality (such as effective spread, rate of price improvement and disimprovement, fill rates, and speed of execution) and sets forth specific instructions on how the measures are to be calculated. The statistical information are categorized by individual security, by five types of orders (e.g., market, marketable limit, at-the-quote limit, inside-the-quote limit, near-the-quote limit), and four order sizes (e.g., 100-499 shares, 500-1999 shares, 2000-4999 shares, and 5000-9999 shares). As a result, users of the market center reports should have great flexibility in determining how to summarize and analyze statistical information. Users of the data are able to analyze order executions for a particular security or for any particular group of securities, as well as for any size or type of orders across those groups of securities. Market centers typically publish the raw data in a pipe delimited ASCII file format that is not viewable to the general public without utilizing a viewing tool or knowing the file layout and using a calculator. This provides an opportunity to provide a much needed central repository of data in an intuitive, informative viewing tool for the public, small broker dealers, and independent financial advisors or professionals. The invention will also archive this data historically and provide charting graphics showing historical trends on each data element on a month to month and market center to market center basis.

In addition the SEC requires broker-dealers to make publicly available for each calendar quarter a report on its routing of non-directed orders in covered securities. The SEC also requires broker-dealers make the quarterly reports readily available via the Internet. The quarterly reports are made publicly available within one month after the end of the quarter addressed in the report. The rule requires that a quarterly report be divided into four separate sections for four different types of covered securities—one for equity securities listed on the NYSE, one for equity securities qualified for inclusion in NASDAQ, one for equity securities listed on the Amex or any other national securities exchange, and one for options. A broker-dealer's quantitative description of order routing must include the percentage of total customer orders for a particular section that were non-directed orders, and the percentages of total non-directed orders for a section that were market orders, limit orders, and other orders. For each of the venues identified in each section of the report, the broker-dealer must disclose the percentage of total non-directed orders for the section routed to the venue, and the percentages of total non-directed market orders, non-directed limit orders, and non-directed other orders for the section that were routed to the venue. The invention will weight the routing percentages from each venue of the sections of broker-dealers' quarterly reports with that venue's corresponding execution statistics to provide a “theoretical” execution quality statistic by broker-dealer as opposed to by a market center as in rule 605. This can be used to assess a general overview of broker-dealers' execution quality on a theoretical basis. This is useful because Broker-Dealers are not required to provide public execution quality reports such as what is required by market centers.

In addition to Rule 605 statistics posted publicly by each trading center, the invention will provide Rule 605 like statistical measurements of real time and historical market data by each trading center authorized to publicly disseminate quote data. Through a real time or daily market data feed, the invention will present Rule 605-like statistical calculations by trade print per trading center compared to the best quote at time of print. Statistics will include: At the Quote Percentage, Avg. Effective Spread, Avg. Quoted Spread, Price Improvement percentage per print and per share, Net Dollars per Share, and Effective Spread over Quoted Spread. The statistics will have the ability to be broken out by rule 605 Order sizes (100-499 shares, 500-1999 shares, 2000-4999 shares, 5000-9999 shares, 10000 shares plus, and All sizes). Charts will be deployed to demonstrate graphical trading trends intraday (hourly), weekly, and monthly.

The Securities and Exchange Commission (“SEC”) has adopted new rules to strengthen the regulatory structure of the U.S. equity markets. One new rule is referred to as the “Order Protection Rule” which requires trading centers to establish, maintain, and enforce written policies and procedures reasonably designed to prevent the execution of trades at prices inferior to protected quotations displayed by other trading centers, subject to an applicable exception. To be protected, a quotation must be immediately and automatically accessible. This presents an opportunity to create real-time, statistical information based on the frequency one trading center may trade through another trading center and also the frequency of when a trading center may or may not be immediately and automatically accessible. The statistics will be compiled for each trading center on an overall basis, on a stock by stock basis adopting Rule 605 share size breakouts, and on an hourly basis as determined by the user. Different segments will also be broken out such as S & P 100 issues, S & P 500 Issues, ETF's, etc. . . . The invention will utilize a live Market Data stream or daily upload of all NMS securities and will map out all new Market Data identifiers to formulate measurements for identifying when markets are immediately and automatically accessible and when certain prints may have occurred at prices inferior to the best published quotations. Time filters will be necessary based on rule requirements (1 second default with user ability to update).

An additional aspect of Regulation NMS requires each national securities exchange and national securities association to adopt, maintain, and enforce written rules that prohibit their members from engaging in a pattern or practice of displaying quotations that lock or cross automated quotations. The invention will calculate statistical data to demonstrate frequency of locked and crossed markets by trading center. Locked or Crossed quotations occur when the highest displayed bid price of one trading center is either equal to or greater than another trading centers lowest displayed offer price or when the lowest displayed offer price of one trading center is equal to or less than another trading center's highest displayed bid price. These statistics will be packaged and made available in a consistent, functional format to the above mentioned invention applications.

### BRIEF SUMMARY OF THE INVENTION

A method and apparatus to automatically seek, import, aggregate, store, relate and make available in a centralized database via the internet, a combination of publicly disclosed/disseminated trade execution, order routing and quote data. Although this data is required to be publicly disclosed to help investors make more informed decisions, it is often too difficult to find, view, and relate or compare each individual source including but not limited to: market center to market center, broker to broker, or trading center to trading center. New statistical measurements will be established to measure performance of Broker Dealer routing practices and Trading Center quote and print performance. The goal of the invention is to create a single repository that can be easily utilized and interpreted by the investing public and professionals alike.

### BRIEF DESCRIPTION OF THE SEVERAL VIEWS OF THE DRAWING

Not applicable

### DETAILED DESCRIPTION OF THE INVENTION

These are the baseline and functional goals of the invention:

Website—The invention will be accessible on the internet.

Central Database—A database will store all mined data, apply business logic and/or formulas to calculate statistical measures, and supply query requests with data and charts. The database will also store user site navigation history in order to create an automatic audit trail.

Software—Software will be applied to create all features and calculations on all invention applications.

Charts—The invention will provide graphical charts demonstrating report results as a visual tool to demonstrate historical trends for comparison purposes.

File Import—File import functions will automatically seek, import, identify and index multiple file types from multiple sources into the central database. (Pipe delimited ASCII, Market Data feed/daily upload, internet screen scraping) All import functionality will be achieved over the Internet with the possible exception of the Market Data feed.

These are the features of the invention with corresponding explanations and definitions:

Rule 605 File Import—The invention will automatically search out and import all publicly posted Rule 605 ASCII files from the internet. The files will be indexed by each reporting market center and stored in the central database. The invention will be proactive in identifying the appropriate schedule for new monthly postings and smart enough to know if a particular market center's file is late, corrupt, or missing. A manual import function will be implemented in the event of any failures or additions. The files are in pipe delimited ASCII format and consists of eleven required columns of information for all orders: (1. # covered orders, 2. # cumulative shares, 3. # cumulative cancelled shares, 4. # shares executed at receiving market, 5. # shares executed at other venue, 6. # shares executed 0-9 seconds, 7. # shares executed 10-29 seconds, 8. # shares executed 30-59 seconds, 9. # shares executed 60-299 seconds, 10. # shares executed from 5-30 minutes, 11. average realized spread. Plus 9 additional columns for market and marketable limit orders: 1. average effective spread, 2. # shares price improved, 3. average price improvement amount, 4. average speed for price improved shares, 5. # shares executed At the Quote, 6. average speed for At the Quote, 7. # shares outside the quote, 8. average amount outside the quote. 9. average speed outside the quote.

Rule 605 Data Parsing—The database will store all ASCII files by period, and market center. All data will be readily accessible by the online query tool for a rolling 1 year period. Business logic will be implemented to calculate all statistical measures and invention application functions.

Web Presentation—The website will provide query functions that are easy to understand, flexible, intuitive, and user friendly. Each query option will provide selections with fixed choices in each category plus a blank box entry field to allow for input of desired search criteria. The design will be crisp with easy to understand tables consisting of rows for each month, quarter, year, market center and columns for each statistical metric. Each query will provide row and column headers along with the query description (i.e. NASDAQ 100 Market Orders for July all market centers).

Covered Order—The term covered order shall mean any market order or any limit order (including immediate-or-cancel orders) received by a market center during regular trading hours at a time when a consolidated best bid and offer is being disseminated, and, if executed, is executed during regular trading hours, but shall exclude any order for which the customer requests special handling for execution, including, but not limited to, orders to be executed at a market opening price or a market closing price, orders submitted with stop prices, orders to be executed only at their full size, orders to be executed on a particular type of tick or bid, orders submitted on a “not held” basis, orders for other than regular settlement, and orders to be executed at prices unrelated to the market price of the security at the time of execution.

Cumulative Shares—The cumulative number of shares of covered orders.

Canceled Shares—The cumulative number of shares of covered orders canceled prior to execution.

Market Center Shares—The cumulative number of shares of covered orders executed at the original receiving Market Center.

Away Shares—The cumulative number of shares of covered orders executed at a venue other than the original receiving Market Center.

Executed Shares 0-9 seconds—The cumulative number of shares of covered orders executed from 0-9 seconds after time of receipt.

Executed Shares 10-29 seconds—The cumulative number of shares of covered orders executed from 10-29 seconds after time of receipt.

Executed Shares 30-59 seconds—The cumulative number of shares of covered orders executed from 30-59 seconds after time of receipt.

Executed Shares 60-299 seconds—The cumulative number of shares of covered orders executed from 60-299 seconds after time of receipt.

Executed Shares 5-30 Minutes—The cumulative number of shares of covered orders executed from 5-30 minutes after time of receipt.

NBBO—National Best Bid and Offer also known as the quote or consolidated best bid and offer and shall mean the highest firm bid and the lowest firm offer for a security that is calculated and disseminated on a current and continuous basis pursuant to an effective national market system plan. (Top of Book)

Average Realized Spread—The term average realized spread shall mean the share-weighted average of realized spreads for order executions calculated, for buy orders, as double the amount of difference between the execution price and the midpoint of the consolidated best bid and offer five minutes after the time of order execution and, for sell orders, as double the amount of difference between the midpoint of the consolidated best bid and offer five minutes after the time of order execution and the execution price; provided, however, that the midpoint of the final consolidated best bid and offer disseminated for regular trading hours shall be used to calculate a realized spread if it is disseminated less than five minutes after the time of order execution.

Average Effective Spread—The term average effective spread shall mean the share-weighted average of effective spreads for order executions calculated, for buy orders, as double the amount of difference between the execution price and the midpoint of the consolidated best bid and offer at the time of order receipt and, for sell orders, as double the amount of difference between the midpoint of the consolidated best bid and offer at the time of order receipt and the execution price.

Price Improvement—The term executed with price improvement shall mean, for buy orders, execution at a price lower than the consolidated best offer at the time of order receipt and, for sell orders, execution at a price higher than the consolidated best bid at the time of order receipt. Can also be considered an “Inside-the-Quote” execution.

Price Improved Shares—For orders executed with price improvement, the cumulative number of shares executed with price improvement.

Price Improvement Amount—For shares executed with price improvement, the share-weighted average monetary amount per share that prices were improved.

Price Improvement Time—For shares executed with price improvement, the share weighted average period from the time of order receipt to order execution.

At the Quote—The term executed at the quote shall mean, for buy orders, execution at a price equal to the consolidated best offer at the time of order receipt and, for sell orders, execution at a price equal to the consolidated best bid at the time of order receipt.

At the Quote Shares—The cumulative number of shares of covered orders executed At the Quote.

At the Quote Time—For shares executed at the quote, the share weighed average period from the time of order receipt until the time of order execution.

Outside the Quote—The term executed outside the quote shall mean, for buy orders, execution at a price higher than the consolidated best offer at the time of order receipt and, for sell orders, execution at a price lower than the consolidated best bid at the time of order receipt.

Outside the Quote Shares—For buy orders, execution at a price higher than the NBBO at the time of order receipt. For sell orders, execution at a price lower than the NBBO at the time of order receipt.

Outside the Quote Amount—For shares executed outside the quote, the share-weighted average monetary amount per share that prices were outside the quoted.

Outside the Quote Time—For shares executed outside the quote, the share-weighted average period from the time of order receipt to the time of order execution.

Net Dollar/Shares—The share weighted net of all executions including price improvement amount, outside the quote amount and at the quote executions.

Average Quoted Spread—The share-weighted average spread of the NBBO (difference between bid and offer) for all executions in a category.

Effective/Quoted—The average effective spread divided by the average quoted spread the result of which is a percentage.

Average Speed—The share-weighted average period of time for all executions in a category between time of receipt and time of execution.

Order Size—The term categorized by order size shall mean dividing orders into separate categories for sizes from 100 to 499 shares, from 500 to 1999 shares, from 2000 to 4999 shares, and 5000 or greater shares. The invention will also provide a feature for all sizes.

Order Type—The term categorized by order type shall mean dividing orders into separate categories for market orders, marketable limit orders, inside-the-quote limit orders, at-the-quote limit orders, and near-the-quote limit orders.

Security Type—The term categorized by security shall mean dividing orders into separate categories for each national market system security that is included in a report.

Rule 606 File Import—The invention will search, locate, and “screen scrape” Broker Dealer Rule 606 Order Routing information. This information is usually posted on each Broker Dealers' website or a 3rd party website such as TAG or TTA (formerly MSI). The files are usually in grid like tables in PDF or HTML formats and not raw data. Screen scraping will be necessary to import and parse the data into the central database.

Rule 606 Data Parsing—The database will parse the screen scraped data by quarter, broker-dealer, section (NYSE, AMEX, NASDAQ, Option), and criteria (% non-directed, % directed, % non-directed market orders, % non-directed limit orders, % non-directed other orders), and venue (market center). This data will be readily available for query on a floating 1 year basis.

Rule 605/606 Data link—The quantitative Rule 606 order routing percentages will be linked to the corresponding venues statistical rule 605 execution quality database.

Rule 606 Theoretical Execution Quality Statistics—Logic will be applied in order to calculate the theoretical execution quality data by broker-dealer. Formulas will be in place to calculate the weighted average for each rule 605 execution statistic using the rule 606 broker-dealer routing percentage by period, section, venue, share size, and criteria (% non-directed, % directed, % non-directed market orders, % non-directed limit orders, % non-directed other orders). The percentage weighting will be applied with the assumption of a 1000 share order. For example a broker-dealer routes 50% of NYSE market orders to venue A and 50% of NYSE market orders to venue B. Venue A shows an average effective spread of 0.028 for NYSE market orders of 100-499 shares and venue B shows an average effective spread of 0.030 for NYSE market orders of 100-499 shares. The broker-dealers' theoretical average effective spread would be 0.029 ((500 share×0.028+500 shares×0.030)/1000 share hypothetical order).

Rule 606 Online Query Tool—The invention will be query-able by all rule 606 criteria combined with rule 605 criteria. For example users will be able to create a report for a particular period by broker-dealer A, broker-dealer B, broker-dealer C, etc, for each section (NYSE, AMEX, NASDAQ,) and by criteria (non-directed, directed, non-directed market, non-directed limit, or non-directed other). In addition, rule 605 choices will be provided for period, stock symbol, stock group, matching “section” or listing exchange, rule 605 share size (100-499, 500-1999, 2000-4999, 5000-9999, or all), and rule 605 execution measures (i.e. effective spread, price improvement share %, price improvement amount, disimproved #, disimproved amount, etc. . . . ). Queries will be allowed to be saved on the invention's applications by username for ease of use by the user.

Market Data Feed—The invention will maintain a direct market data feed for NYSE, NASDAQ, AMEX, and Options. The market data will be uploaded on a daily basis as well as real time. This is achieved through direct links with exchange market data facilities such as SIAC, NASDAQ, and OPRA or 3rd party vendors.

Market Data Parsing—Unlike Rule 605 data parsing, the invention's application will apply logic in calculating statistics based on the market data feed. Every trade print in the market data feed will be compared to the previous NBBO and will be flagged in the database as A—At the Quote, P—Price Improved (better than Quote), D—Disimproved (outside-the-quote). These flags will be stored in the database along with every print in order to provide record counts for all criteria and calculate the rates (percentage of total) for each. In addition to flagging the above mentioned execution type flags, the database will also capture and store the Quoted Spread (share weighted average difference between bid and ask of the NBBO) for every trade print in order to calculate average quoted spreads, average effective spreads, and average realized spreads. The database will also calculate any monetary amounts improved or disimproved (distance between the price of the trade print and the most recent NBBO). Lastly, the database will calculate the elapsed time of print between the time of print and the time of the last quote captured. The elapsed time will correspond to each flag type (A—At the Quote, P—Price Improved (better than Quote), D—Disimproved (outside-the-quote).

Market Data Statistical Measures—The same Rule 605 criteria for symbol, group of symbols, period, share sizes are provided with 2 exceptions: 1. No order types such as market, marketable limit, at-the-quote limit, near-the-quote limit, and inside-the-quote limit since the market data feed does not provide that information, and 2. Print speed will be calculated instead of execution speed since the market data stream does not include original order entry time. The print speed will be calculated as the period from time of print to the last previous quote that was either A—At the Quote, P—Price Improved (better than Quote), D—Disimproved (outside-the-quote). Results will be provided by Exchange Identifier (i.e. N, A, Q, C, P, etc. . . . ) for comparisons between markets. In addition all trading center data will be totaled to provide an industry average benchmark.

Market Data Time Filter—The invention will apply a time filter to Market Data calculations involving the previous quote. A one second delay will be set as the default with the ability for each user to update to a preferred time filter in seconds. These preferences will be captured in the navigation log. The time filter will look for the most recent quote previous to the filter setting. For example if a trade printed at 11:25:30 the one second filter will look for the most previous quote prior to 11:25:31. This allows the calculation to be concurrent with Regulation NMS standards.

Regulation NMS Statistics—The invention's Regulation NMS statistics application will introduce new statistical measures based on new SEC Regulation NMS rules for order protection and locked/crossed markets that will have taken affect around the 2nd quarter of 2007. This feature will have the same layout, look and feel of all other invention applications.

Regulation NMS Uniform Indicators—The joint-SRO market data networks (“Networks”), which disseminate consolidated quotation data for NMS stocks to the public, have agreed to adopt uniform identifiers for manual and automated quotations. Quotations will have a condition code “B” if manual on the bid, “A” if manual on the offer, and “H” if manual on both the bid and the offer. Quotations without any condition codes will be considered automated. In addition, the Networks currently use a number of condition codes for quotations (such as “non-firm” quotations) that render them ineligible for inclusion in the Networks' calculation of a national best bid and offer. None of these quotations are eligible to be automated quotations and, consequently, cannot qualify as protected quotations under Rule 611. Theses condition codes will be captured in the central database with each applicable quote and used to derive new quote performance statistics.

Regulation NMS Exception Indicators—The SEC sets forth exceptions that are designed primarily to promote intermarket price priority. A trading center's policies and procedures to prevent trade-throughs under Rule 611(a) are not required to prevent transactions that are executed in compliance with these exceptions. In the NMS Release, the Commission noted that increased transparency concerning excepted trades would be beneficial because it would give timely notice to the public that a trade qualified for an exception . . . . At the time of the invention's concept, the joint-SRO market data plans that operate the Networks were working to select uniform identifiers for trades that are executed pursuant to the 611(b) exceptions. The Networks will disseminate these identifiers to the public in the consolidated trade data for NMS stocks. Once identified these exception indicators will also be captured in the central database and used to derive new quote performance statistics.

New Statistical Measures—The purpose of this application of the invention is to introduce new statistical measures derived from the continuous joint SRO market data network that will demonstrate trading centers' compliance with the new Reg. NMS rules. Each statistic will be retrievable by period and/or real-time, by Trading Center, or by symbol or groups of symbols, and by size increments (100-499, 500-1999, 2000-4999, 5000-9999,10000 over, and all sizes).

Quote Count—The cumulative number of best bids and offers (BBO) displayed at the “top of book” by all trading centers.

Print Count—The cumulative number of trade prints disseminated by all trading centers that do not display an exception indicator.

Manual Quote Rate—For quotes with a “manual” indicator of B, A, or H, the percentage of the cumulative number of times of each and all of these indicators are displayed vs. the total number of quotes disseminated.

Trade Through Rate—For trade prints at prices inferior to the previous displayed NBBO, the rate at which one trading center's prints are inferior to its own or other trading centers NBBO. Calculated as a percentage of the cumulative number of trade through events vs. the total cumulative number of trades printed without an exception indicator. A user will be able to click on the number of trade throughs for a given period and “drill down” to expand and view all applicable information attached to each trade print that created the trade through event.

Exception Rate—For trade prints that contain any exception identifier (once designated) the rate at which one trading center prints trade exceptions vs. the total cumulative number of trades printed. The statistics will be provided as total exceptions and broken down by the individual exceptions.

Locked/Crossed Rate—For trading centers' BBO that during the course of the trading day equals or is inferior to (locks or crosses) other trading centers BBO's, the rate at which each trading center locks or crosses another trading center BBO calculated as the percentage of the cumulative number of locked/crossed events Vs. the total cumulative number of top of book quotes displayed per trading center and overall. A user will be able to click on the number of total locked/crossed occurrence and be able to “drill down” to expand and view all available information attached to the trade print that caused each occurrence. Rates will be calculated individually for Locked, individually for Crossed, and as a combination of Locked/Crossed for each trading center and industry wide. The definition of locked shall mean when the bid of one trading center equals the offer of another trading center at the same time during regular market hours. The definition of crossed shall mean when the bid of one trading center is greater than the offer of another trading center by at least 0.01 at the same time during regular market hours, or when the offer of one trading center is less than the bid of another trading center by at least 0.01 at the same time during regular market hours.

Average Displayed Size—The term average displayed size shall mean the average number of shares displayed for each top of book quote during regular market hours. This will be calculated by dividing the cumulative number of total shares displayed at each top of book quote per trading center divided by the total cumulative number of top of book quotes displayed by a market center during regular market hours. Also calculated industry-wide combining all trading centers to provide an industry benchmark.

Online Query Tools—Users will utilize an online query tool to retrieve all data from the central database and customize their desired statistical measures. Queries will be authorized by username/password and allow for various query types by Trading Center, Stock Symbol, Equity Index Symbol (i.e. NASDAQ 100, S&P 500 etc), Listing Market (i.e. -NYSE, Q-NASDAQ, A-AMEX etc. . . . ), Bucket size (100-499, 500-1999, 2000-4999, 5000-9,999, 10,000 and over, and all sizes), by Period (Hour Day, Week, Month, Quarter, Year), and all available Statistical Measures. (i.e. average effective spread, price improvement, covered shares, net dollars/shares, price improvement amount, number of quotes, number of prints, number of displayed shares, number of manual quotes, percentage of manual quotes, number of trade throughs, percentage of trade throughs, number of Locked, percentage Locked, number Crossed, percentage Crossed, number Locked/Crossed, percentage Locked/Crossed, etc. . . . ). Rule 606 queries will allow retrieval by Broker Dealer. Users will be able to

1. A consolidated data aggregation, query and viewing method that combines and relates multiple sets of statistical trade and execution data including SEC Regulation NMS Rule 605 Execution Quality Statistics, SEC Regulation NMS Rule 606 Order Routing Percentages and the Consolidated Quotation System trade and quotation data from multiple sources into a centralized database. This database is a turnkey solution for consolidating all publicly available trade and execution data from multiple sources into a single, easy to use repository that will be available on the internet to validated users including the general public. Statistical measures will be retrievable through an internet query tool by a variety of factors including but not limited to period, trading center, broker dealer, order type, order size, symbol and/or statistic type.

2. The method claimed in claim 1, wherein all publicly available market centers' Rule 605 execution quality reports will be imported, identified, aggregated and parsed into a centralized database and viewable to system users and integrated with Rule 606 broker dealer order routing percentages. This data is usually available in a flat ASCII file format that is impossible for the general public to view and interpret. The data will be categorized by individual security, by five types of orders; market, marketable limit, at-the-quote limit, inside-the-quote limit, near-the-quote limit and four order sizes; 100-499 shares, 500-1999 shares, 2000-4999 shares, and 5000-9999 shares. The files consist of eleven required columns of information for all orders including but not limited to number of covered orders, number of cumulative shares, number of cumulative cancelled shares, number of shares executed at receiving market, number of shares executed at other venue, number of shares executed 0-9 seconds, number of shares executed 10-29 seconds, number of shares executed 30-59 seconds, number of shares executed 60-299 seconds, number of shares executed from 5-30 minutes, and average realized spread. Plus 9 additional columns for market and marketable limit orders: including average effective spread, number of shares price improved, average price improvement amount, average speed for price improved shares, number of shares executed At the Quote, average speed for At the Quote, number of shares outside the quote, average amount outside the quote and average speed outside the quote.

3. The method claimed in claim 1, wherein Rule 606 Order Routing Percentages published on the internet by broker dealers will be imported, identified, aggregated and parsed into the central database. Routing percentages of broker dealers will be weighted against all corresponding rule 605 execution quality statistics to provide a theoretical measure of individual broker dealer execution quality. This new method is useful because broker dealer execution quality measures are not required and therefore not currently available to the general public. Formulas will be establish to calculate the weighted average of every applicable rule 605 execution statistic including but not limited to period, security type, venue, share size, and routing percentage, including; percentage of non-directed orders, percentage of directed orders, percentage of non-directed market orders, percentage of non-directed limit orders and percentage of non-directed other orders.

4. The method claimed in claim 1, wherein market data of all NMS Securities quotes and trades from the Consolidated Quotation system data stream will be aggregated and parsed into the central database for query of new quote performance statistical measures corresponding to new Regulation NMS rules 610 which addresses access to markets, rule 611 which provides intermarket price priority for displayed and accessible quotations and rule 612 which establishes minimum pricing increments. More specifically, formulas will be applied to establish new statistical measures for number and rate of occurrences of manual markets per trading center, number and rate of occurrences for a variety of trade exceptions reported, number and rate of occurrence of a trading center displaying quotes equal, superior, or inferior to the inside bid and ask, number and rate of occurrences of a trading center trading through the best displayed inside quote and number and rate of occurrences of a trading center locking and crossing the best displayed inside quote at any given time during market hours. These measurements are considered new since they pioneer statistical measurements of new regulation NMS rules that are not yet effective at the time of concept of this invention.

5. The method claimed in claim 2, wherein consolidated quotation system trade and quote data will be formulated into Rule 605 like statistics by measuring every trade print against the most previously displayed quote within an applied time-filter. These execution quality measures have only been applied to private order data in the past and not applied to publicly disseminated quote and trade data. The purpose of this new approach is to provide greater insight into trading center quote dissemination performance and trade print quality.
